(19) United States
(12) Patent Application Publication
(10) Pub. No.: US 2014/0068526 A1
(43) Pub. Date: Mar. 6, 2014

(54) METHOD AND APPARATUS FOR USER INTERACTION

(71) Applicants: Shahar Figelman, Tel Aviv (IL); Shy Borowitsh, Tel Aviv (IL)

(72) Inventors: Shahar Figelman, Tel Aviv (IL); Shy Borowitsh, Tel Aviv (IL)

(73) Assignee: THREE BOTS LTD, Tel Aviv (IL)

(21) Appl. No.: 13/754,918

(22) Filed: Jan. 31, 2013

Related U.S. Application Data
(60) Provisional application No. 61/595,041, filed on Feb. 4, 2012.

(51) Int. Cl. G06F 3/01

(52) U.S. Cl. CPC G06F 3/017
USPC 715/863

(57) ABSTRACT

The subject matter discloses a method of screen navigating; the method comprises the steps of classifying a gesture of a body organ as an action of screen navigation capturing an image of a body organ; analyzing said image to determine whether the image matches said gesture of said body organ; and executing said action of screen navigation if said image matches said body organ gesture.

### FIELD OF THE INVENTION

The present invention relates generally to user interaction in computing devices and in particular to natural user interface.

### BACKGROUND OF THE INVENTION

The interaction between computing devices and users continues to improve as computing platforms become more powerful and able to respond to a user in many new and different ways; for instance, employing cameras and gesture recognition software to provide a natural user interface. With a natural user interface, a user's body parts and movements may be detected, interpreted, and used to control a computing device, applications, sites, games, virtual worlds, TV programs, videos, documents, photos, etc. Augmented reality is a technique that appendences a computer image (e.g. three dimensional (3D) content, video, virtual objects, document, photo) over the user's direct view of the real world. Such technology is used in visual media such as movies, television and video games.

### BRIEF SUMMARY

One exemplary embodiment of the disclosed subject matter is a method of screen navigating. The method comprises the steps of classifying a gesture of a body organ as an action of screen navigation; capturing an image of a body organ; analyzing the image to determine whether the image matches the gesture of the body organ and executing the action of screen navigation if the image matches the body organ gesture. According to some embodiments the body organ being a hand. According to some embodiments the body organ being a face.

One other exemplary embodiment of the disclosed subject matter is a method of activating a command on a computerized device; the method comprises the steps of classifying a gesture of a body organ as an action of screen activation; capturing an image of the body organ; analyzing the image to determine whether the image matches the gesture; and sending a message to a second computerized device if the image matches the gesture; wherein the message being for activating a command on the second computerized device according to the hand gesture. According to some embodiments the command comprises executing screen navigation. According to some embodiments the command comprises manipulating a display of the second computerized device. According to some embodiments the body organ being a hand. According to some embodiments the body organ being a face.

One other exemplary embodiment of the disclosed subject matter is a method of activating a command on a computerized device; the method comprises the steps of classifying a voice pattern as an action of screen activation capturing voice sample of a user; analyzing the voice sample determine whether the image matches the voice pattern; and sending a message to a second computerized device if the voice sample matches the voice pattern; wherein the message being for activating a command on the second computerized device according to the voice pattern. According to some embodiments the command comprises executing screen navigation. According to some embodiments the command comprises manipulating a display of the second computerized device.

### BRIEF DESCRIPTION OF THE DRAWINGS

FIG. 1 is an exemplary block diagram showing a computing device for user interaction in accordance with some exemplary embodiments of the subject matter;

FIG. 2 is a flow diagram of a process of enabling Augmented Reality hand tracking user interaction in accordance with some exemplary embodiments of the subject matter;

FIG. 3 is a flow diagram of a process of enabling Augmented Reality face tracking user interaction in accordance with some exemplary embodiments of the subject matter;

FIG. 4 is a flow chart of a gesture-based control method for screen navigation in accordance with some exemplary embodiments of the subject matter;

FIG. 5, FIG. 5A and FIG. 5B show a scene in which a user holds a mobile device with one hand and with the other hand reaches behind the device, in accordance with some exemplary embodiments of the subject matter;

FIG. 6 illustrates an overhead view of a user interacting with a virtual object, using the computing device's front camera, in accordance with some exemplary embodiments of the subject matter;

FIGS. 7, 7A, 7B, 7C, 7D, 7E and 8 are schematic diagrams illustrating exemplary gestures, in accordance with some exemplary embodiments of the subject matter; and

FIG. 9 is a flow chart of a voice control method for screen navigation in accordance with some exemplary embodiments of the subject matter.

### DETAILED DESCRIPTION OF THE INVENTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The term “hand” as used hereinafter may include one or more hands, the palm of the hand, the back side of the hand, fingers or part of the fingers, the thumb, the wrist and forearm, etc. In some cases the gestures are performed by a bare hand. In some cases the gestures are intuitive.

The term “hand gestures” as used hereinafter may include a movement or change of position of the hand or hands, fingers or part of the fingers, the thumb, the user's wrist and forearm, tilting the hand, moving it up, down, left, right, inward or outward, side to side, etc.

The term “representation of the hand” as used hereinafter may include a 2D image, 3D image, photo, drawing, video, a glove, an avatar's hand, etc.

The term “face” as used hereinafter may include the head and part of the head, the face and part of the face, eyes or part of the eyes, the nose, ears or part of the ears, mouth, etc.

The term “face gestures” as used hereinafter may include a movement or change of position of the user's head and/or face, eyes, ears, nose, mouth and expressions conducted by the user's face, etc.

The term “representation of the face” as used hereinafter may include a 2D image, 3D image, photo, drawing, video, a mask, an avatar's face, etc.

The term “voice commands” as used hereinafter may include separate words, sentences, voices, sounds, and a combination thereof.

The term “virtual object” as used hereinafter described an object that is part of a digital image. In some cases the digital image is a video image that is part of a video stream or a computerized game. The object may represent a virtual character, may be a part of a virtual world. In some cases the virtual object is a graphical object; in some other cases the virtual object is an image or part of an image that is captured by a camera. In some cases the object may represent a document or a photo.

The term “computing device” as used hereinafter may include a cell phone, a smartphone, a media player (e.g., MP3 player), portable gaming device, PC, laptop, tablet, TV, head-mounted display, contact lenses display or any type of handset device having a display.

The term “manipulate the display” as used hereinafter may include causing a change of the virtual object's position, movement, structure, appearance, action and operation, causing a change in the operation flow, or game flow which may cause a change to the scene, causing a change to a 3D scene, a 2D scene, rotating the image on the display, zooming out or zooming in the image on the display etc.

The term “screen” as used hereinafter may include, in addition to the computing device's screen and/or display, an application, a site, a game, a virtual world, a TV program, a screen's computerized menu, a video, a document, a photo etc.

The term “action of screen navigation” as used hereinafter may include any function that control a screen navigation, such as executing a function, moving to the next function, moving to the previous function, opening and closing of a menu, opening and closing of a category, going back to home page/starting page, moving to the next or previous page, scrolling down or up in a page and the like.

Methods and systems for using a computing device for a natural interaction with virtual objects displayed on the device are described in the various figures. The use of a computing device hardware and software enables hand interaction with a virtual object by enabling a user to see the direct effect of the user's hand movement and gestures on the virtual object on the display. In this manner, the user's hand, or a representation of the hand, is shown on the display, maintaining the visual coherency between the user's hand and the virtual object. In another embodiment the use of a computing device hardware and software enables a user's face, or a representation of the face, to interact with a virtual object, maintaining the visual coherency between the user's face and the virtual object. In another embodiment any other part of the user's body or a combination of parts is used for interacting with the display. In another embodiment voice commands enable a user's hand, face or any other part of the user's body or a combination of parts, to interact with the display.

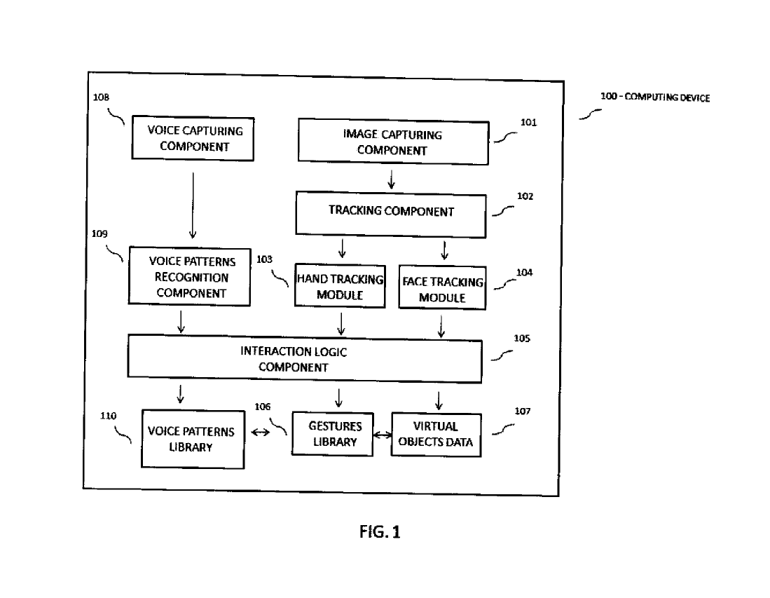

FIG. 1 is an exemplary block diagram showing a computing device for user interaction in accordance with some exemplary embodiments of the subject. A computing device 100 has a display component (not shown) for displaying virtual objects and data 107 which may be stored in mass storage or in a local cache (not shown) on device 100 or may be downloaded from the Internet or from another source.

An image capturing component 101 is configured for capturing an image of the user's body or an image of a part of the user's body. The image capturing component 101 may include one or more conventional 2D cameras and 3D (depth) cameras and non-camera peripherals. In accordance with some embodiments, the image capturing component 101 may be implemented using image differentiation, optic flow, infrared detection and by 3D depth cameras. In some cases the part of the user's body is the user's hand, fingers, and the user's face. The tracking component 102 is configured for tracking the position of the user's hand, fingers and face, within the range of detection. In the current exemplary embodiment, hand tracking data is transmitted to the hand tracking module 103. In another embodiment, tracking component 102 may also track the user's head and face. In this case, head and face tracking data is transmitted to the face tracking module 104. The tracking position data is transmitted to the hand tracking module 103 and to the face tracking module 104 and each identifies features that are relevant to each module.

Hand tracking module 103 identifies features of the user's hand positions, including, in one embodiment, the positions of the hand or part of the hand, fingers or part of the fingers, wrist, and arm. The hand tracking module 103 determines the location of the hand, fingers, wrist, and arm in the 3D space, which has horizontal, vertical, and depth components. Data from the hand tracking module 103 is inputted to the interaction logic component 105.

Face tracking module 104 identifies features of the user's head and face positions, including, in one embodiment, the position of the user's head. The face tracking module 104 determines a vertical and horizontal alignment of the user's head with the computing device and the virtual object. In another embodiment, the user's face may also be tracked which may enable changes in the virtual object to reflect movement and gestures in the user's face. In one embodiment, the user's head and face are visually coherent with the hand movement as shown in the computing device's display, enabling a user to interact with a virtual object using the user's hand, fingers, head and face gestures and movement. Data from the face tracking module 104 is inputted to the interaction logic component 105.

The interaction logic component 105 determines whether the images captured in the hand tracking module 103 and the face tracking module 104 match one of the predefined gestures in the gestures library 106. The interaction logic component 105 analyzes the data transmitted from the hand tracking module 103 and the face tracking module 104, classifies the gesture and turn to the gesture's library 106 to determine whether the images captured in the hand tracking module 103 and the face tracking module 104 match one of the predefined gestures.

The gestures library 106 holds a predefined list of gestures. In one embodiment, the gestures library 106 holds a predefined list of hand gestures and face gestures.

A voice capturing component 108 is configured for capturing voice conducted by the user, through the microphone of the computing device. The voice patterns recognition component 109 is configured for discrete spoken words or phonemes contained within words, or voice commands. The processing of the voice commands is usually accomplished using what is known as a speech engine. In this case, data from voice patterns recognition component 109 is inputted to the interaction logic component 105.

The interaction logic component 105 analyzes the data transmitted from the voice patterns recognition component 109 and classifies whether the voice commands captured in the voice patterns recognition component 109 match one of the predefined voice commands in the voice patterns library 110.

The voice patterns library 110 holds a predefined list of voice commands.

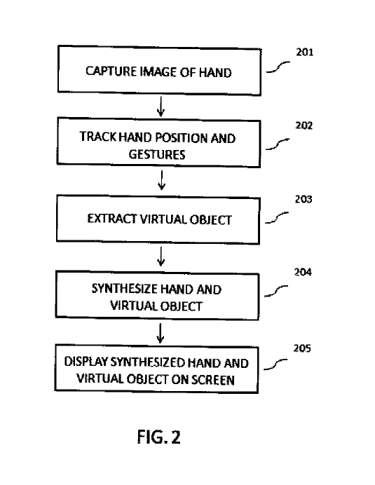

FIG. 2 is a flow diagram of a process of enabling Augmented Reality hand tracking user interaction in accordance with some embodiments of the subject matter.

Augmented reality is a technique that appendences a computer image over a viewer's (user) direct view of the real world, in real-time or not in real-time. The position of the viewer's head, objects in the real world environment and components of the display system (e.g. virtual objects) are tracked, and their positions are used to transform the image so that it appears to be an integral part of the real world environment. While embodiments of the invention are generally described in terms of an augmented reality scene which is generated based on a captured image stream of a real world environment, it is recognized that the principles of the present invention may also be applied to a virtual reality scene (no real world elements visible).

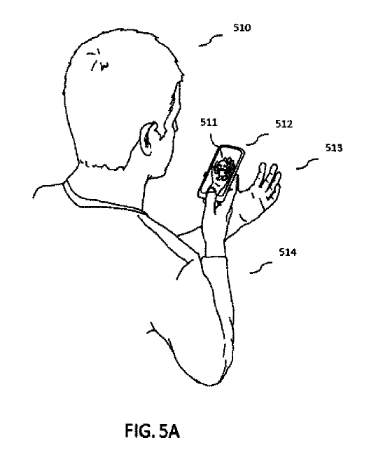

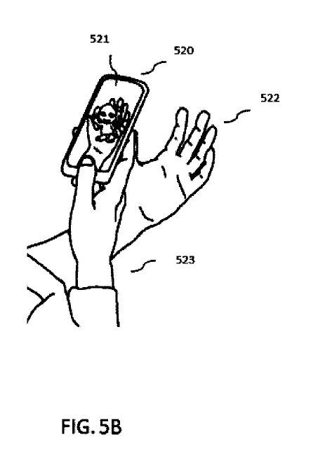

The process described in FIG. 2 starts after the user has powered on the computing device 100 which may be mobile, nomadic, or stationary. The user begins by reaching the hand behind the computing device. At step 201 a capturing component captures the user's hand figure. At step 202 a tracking component detects the presence of the user's hand and any gestures conducted by the hand. The user starts moving the hand, either by moving it up, down, left, right, or inward or outward (relative to the computing device) or by gesturing (or both). In one embodiment, the user can hold the hand still behind the computing device (without moving). The initial position of the hand and its subsequent movement can be described in terms of x, y, and z coordinates. There are various ways for the tracking step to be done. One conventional way is by detecting the skin tone of the user's hand and contour extraction. Additionally, the movement of the computing device 100 may be tracked based on information from motion sensitive hardware within the computing device 100, such as an accelerometer, magnetometer, or gyroscope. At step 203 a virtual object is extracted and is synthesized with the hand in step 204. The user moves the hand behind the device in a way that causes the digital representation of the hand on the display to collide with the virtual object. The synthesis of the virtual object with the user's hand (or another part of the body) may be done by detecting points and by restoring a real world (e.g., physical world) coordinate system from the detected points. The detected points may be interest points, or fiduciary markers, or optical flow in the camera images. The detection includes feature detection methods like corner detection, blob detection, edge detection or thresholding and/or other image processing methods. The restoring comprises restoring a real world coordinate system from the data obtained in the first part. Some methods assume objects with known geometry (or fiduciary markers) present in the scene. In some of those cases the scene 3D structure should be pre-calculated beforehand. That is, the user hand gestures in the physical world execute actions that relate and manipulate the display of virtual object on the computing device. In one embodiment, the user can view the virtual object through the display of the computing device. As the user moves the computing device around in the 3D space, the virtual object may look back at the user, aligned (or not) with the computing device. With reference to FIG. 2, a rear view of a computing device 100 is shown, in accordance with an embodiment of the invention. A rear-facing camera (not shown) is provided for capturing images and video of virtual objects and scenery which is located behind the computing device 100. The captured video from the rear-facing camera may be displayed on the display in real-time (or not in real-time), and may be synthesized with virtual objects so as to provide an augmented reality scene that is displayed to a user. In one embodiment, FIG. 5 illustrates the user holding the computing device in one hand and reaching with the other hand behind the computing device 501. As illustrated in FIG. 5A the virtual object extracted and synthesized to the user's hand. In one embodiment, a virtual representation of the user's hand that may be aligned with the user's hand may be included, such as a 2D image, 3D image, photo, drawing, video, a glove, an avatar's hand, etc.

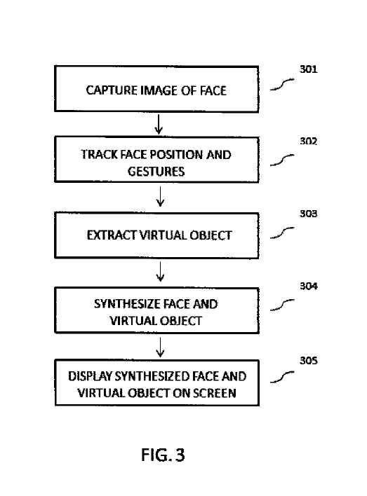

FIG. 3 is a flow diagram of a process of enabling Augmented Reality face tracking user interaction in accordance with one embodiment.

The process described in FIG. 3 starts after the user has powered on the computing device 100 which may be mobile, nomadic, or stationary. That is, there is a vertical and horizontal alignment of the user's face with the computing device 100. At step 301 a capturing component captures the user's face figure. At step 302 a tracking component detects the presence of the user's face and any gestures conducted by the face. The user starts moving the face, either by moving it up, down, left, right, or inward or outward (relative to the computing device) or by gesturing (or both). In one embodiment, the user's face can be aligned to the computing device 100 (without moving). The initial position of the face and its subsequent movement can be described in terms of x, y, and z coordinates. At step 303 a virtual object is extracted and synthesized with the face in step 304. That is, the user face gestures in the physical world execute actions that relate and manipulate the display of virtual object on the computing device.

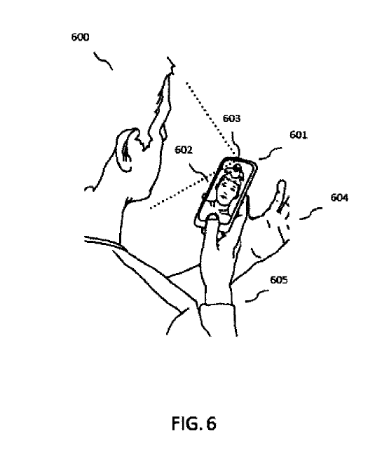

In another embodiment, the user image stream is analyzed to determine facial expressions of the user. In one embodiment, the direction that the user is facing and/or the movement of the user's eyes, ears, nose and mouth are tracked through analysis of the user image stream, so as to determine where the user is looking or facing. In another embodiment, the user image stream can be analyzed to determine gestures of the user, such as smiling, winking, etc. In another embodiment of the invention, physical attributes related to and of the user can be determined, such as hair color, eye color, skin type, eyeglasses shape, etc. In various other embodiments of the invention, any of various kinds of expressions, movements, positions, or other qualities of the user can be determined based on analysis of the user image stream, without departing from the scope of the present invention. In one embodiment of the invention, as illustrated in FIG. 6, the user is facing the front-facing camera. The user's face is displayed on the display and an interaction with the virtual object is executed. In this embodiment, the virtual object 603 flies from the user's hand 604 toward the user's face on the screen 602. In one embodiment, an action on the display causes the computing device's view to move from rear-camera view (for example, as illustrated in FIG. 5A) to a front-camera view (for example, as illustrated in FIG. 6), or the other way around (e.g., move from a front-camera view to a rear-camera view). A front-facing camera (not shown) is provided for capturing images and video of a user, of the computing device 601, or of other objects or scenery which are in front of the computing device 601. In one embodiment of the invention face gestures carried out by User A may manipulate a display of User B (or others) computing device.

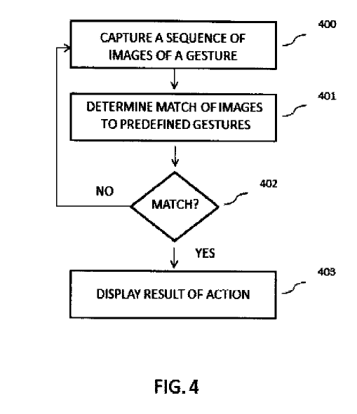

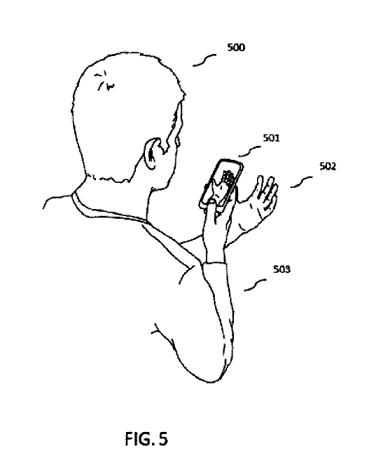

FIG. 4 is a flow chart diagram of a gesture-based control method for screen navigation in accordance with some exemplary embodiments of the subject matter. In one embodiment a gesture conducted by the user's hand may execute an action of screen navigation. In one embodiment, more than one gesture at a time may be conducted (for example, two gestures may be conducted at the same time and execute two functions at the same time).

In step 400, the image capturing module 101, as described in FIG. 1, captures a sequence of images of a gesture, and converts the images captured into a digital format.

In step 401, the interaction logic component 105, as described in FIG. 1, analyzes the images to determine whether the images captured in step 400 match one of the predefined gestures.

In step 402, the interaction logic component 105 classifies the gesture and to determine if the images captured in step 400 match one of the predefined gestures. If a match is found, the flow proceeds to step 403, displaying a result of the action on the screen. Otherwise, the flow goes back to step 400.

FIG. 5 shows a scene that a user holds a mobile device with one hand and with the other hand reaching behind the device, in accordance with some exemplary embodiments of the subject matter. FIG. 5A illustrates an overhead view of a user interacting with a virtual object, in accordance with some embodiment of the subject matter. FIG. 5B illustrates a more detailed view of a user interacting with a virtual object, in accordance with some exemplary embodiments of the subject matter. In one embodiment of the invention, the hand of the user, as described in FIG. 5A, triggers the user interaction with a virtual object (e.g., if the hand of the user is not displayed, the virtual object is not displayed, etc.).

FIG. 6 illustrates an overhead view of a user interacting with a virtual object, using the computing device's front camera, in accordance with some exemplary embodiments of the subject matter.

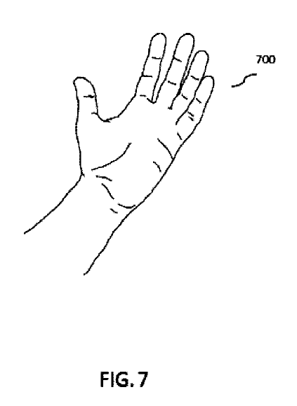

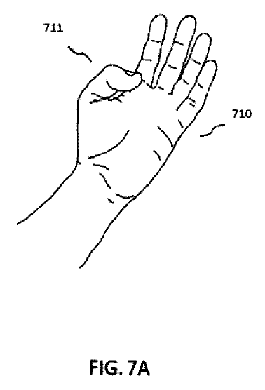

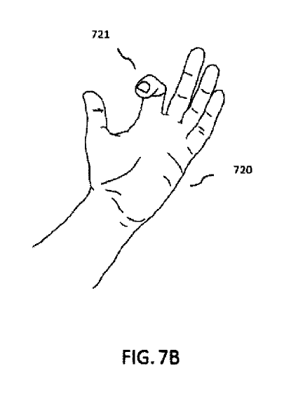

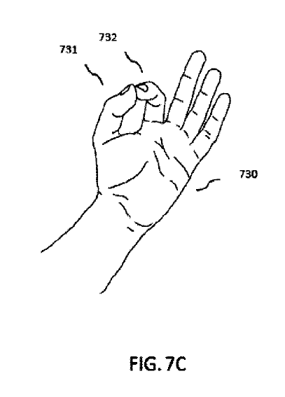

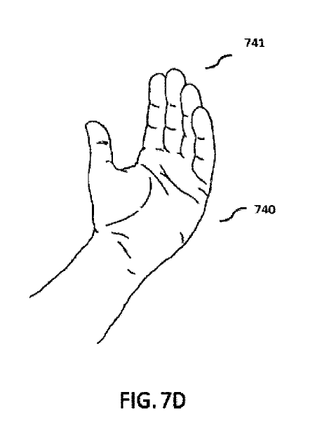

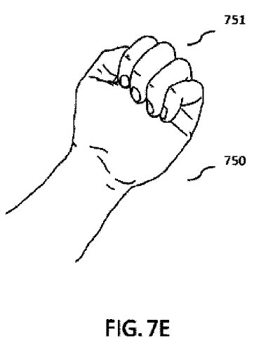

FIGS. 7, 7A, 7B, 7C, 7D and 7E are schematic diagrams illustrating exemplary gestures used for navigating a screen, in accordance with some exemplary embodiments of the subject matter. FIG. 7 illustrates the starting position of the hand, in which the fingers are spread apart.

The first gesture, as illustrated in FIG. 7A may be assigned with a single go forward (next) function. In this embodiment, a single go forward (next) function, refers to the first gesture is made by a move of the thumb towards the palm of the hand 711 and back to starting position 700, as described in FIG. 7. In one embodiment of the invention, a single go forward (next) function refers to a screen navigation method in which a single go forward (next) gesture 711 refers to navigate over the functions (and menus) of the screen (e.g., application, site, game, virtual world, TV program, video, document, photo, etc.). In one embodiment, a user can make a single go forward (next) gesture 711 and navigate over each (or part) of the screen functions (e.g., go to “play” page, open the camera, go to “info” page, go to “settings” page, etc.). In one embodiment, a user can make a single go forward (next) gesture 711 and scroll down a document.

The second gesture, as illustrated in FIG. 7B may be assigned with a single go backward function. In this embodiment, a single go backward function refers to the second gesture, is made by a move of the index finger towards the palm of the hand 721 and back to starting position 700, as described in FIG. 7. In one embodiment of the invention, a single go backward function refers to a screen navigation method in which a single go backward gesture 721 refers to navigate over the functions (and menus) of the screen (e.g., application, site, game, virtual world, TV program, video, document, photo, etc.). In one embodiment, a user can make a single go backward gesture 721 and navigate backwards over each (or part) the application functions (e.g., go to “play” page, open the camera, go to “info” page, go to “settings” page, etc.). In this embodiment, the single go backward gesture 721 functions as the complementary gesture of the first single go forward gesture 711, enabling the user to navigate the screen forward and backward. In one embodiment, a user can make a single go backward gesture 721 and scroll up a document.

In one embodiment of the invention, the first gesture, as illustrated in FIG. 7A may be assigned with a select function. In one embodiment, a user can make a select gesture, and select (open) the screen functions (e.g., open “play” page, open the camera, open “info” page, open “settings” page, etc.).

In another embodiment of the invention, the second gesture, as illustrated in FIG. 7B may be assigned with a single go forward (next) function. In one embodiment, a user can make a single go forward (next) gesture, and navigate over each (or part) of the screen functions (e.g., go to “play” page, open the camera, go to “info” page, go to “settings” page, etc.). In another embodiment of the invention, the second gesture, as illustrated in FIG. 7B may be assigned with a select function. In another embodiment, a user can make a select gesture, and select (open) the screen functions (e.g., open “play” page, open the camera, open “info” page, open “settings” page, etc.).

The third gesture, as illustrated in FIG. 7C may be assigned with a select function. In this embodiment, a select function refers to the third gesture, is made by a pinch gesture made by the thumb and index finger. In this embodiment, the tips of the thumb 731 and the index finger 732 are in contact and back to starting position 700, as described in FIG. 7. In one embodiment of the invention, a select function refers to a screen navigation method in which a select gesture, as described in FIG. 7C refers to navigate over the functions (and menus) of the screen (e.g., application, site, game, virtual world, TV program, video, document, photo, etc.). In one embodiment, a user can make a select gesture, as described in FIG. 7C and select (open) the screen functions (e.g., open “play” page, open the camera, open “info” page, open “settings” page, etc.).

The fourth gesture, as illustrated in FIG. 7D may be assigned with a go one level up function. In this embodiment, a go one level up function refers to the fourth gesture, is made by a move of all the fingers besides the thumb towards the palm of the hand 741. In this embodiment, all the fingers besides the thumb move towards half way to the palm of the hand and back to starting position 700, as described in FIG. 7. In one embodiment of the invention, a go one level up function refers to a screen navigation method in which a go one level up gesture 741 refers to navigate over the functions (and menus) of the screen (e.g., application, site, game, virtual world, TV program, video, document, photo, etc.). In one embodiment, a user can make a go one level up gesture 741 and go from sub-category level to a category level (for example, go from “accessories” items sub-category to all categories menu in which the “accessories” category included).

In one embodiment of the invention, the fourth gesture, as illustrated in FIG. 7D may be assigned with a go back to home page (e.g., starting page/screen of the application, site, game, virtual world, TV program, video, document, photo, etc.). In one embodiment, a user can make a go back to home page gesture and go from any function (sub-category function, category function, menu function, etc.) back to the screeds home page (e.g., application, site, game, virtual world, TV program, video, document, photo, etc.).

The fifth gesture, as illustrated in FIG. 7E may be assigned with a go back to home page function. In this embodiment, a go back to home page function refers to the fifth gesture, is made by a closing all of the fingers to a fist position 751. In this embodiment, all the fingers move towards to the palm of the hand to a fist position 751 and back to starting position 700, as described in FIG. 7. In one embodiment of the invention, a go back to home page function refers to a screen navigation method in which a go back to home page gesture 751 refers to navigate over the functions (and menus) of the screen (e.g., application, site, game, virtual world, TV program, video, document, photo, etc.). In one embodiment, a user can make a go back to home page gesture 751 and go from any function (sub-category function, category function, menu function, etc.) back to the screeds home page (e.g., application, site, game, virtual world, TV program, video, document, photo, etc.).

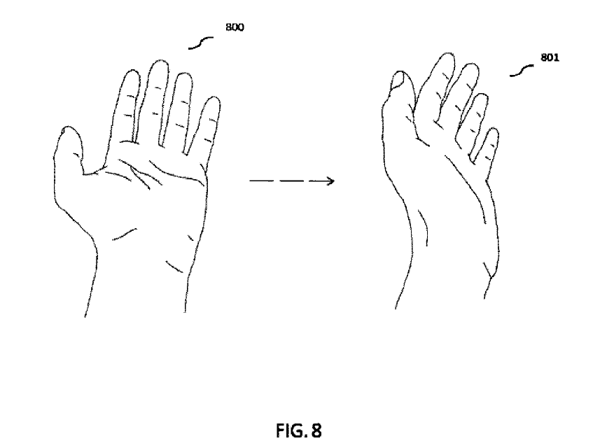

FIG. 8 is a schematic diagram illustrating gestures to manipulate a display of a computing device in accordance with some exemplary embodiments of the subject matter. In one embodiment of the invention, a user can make a gesture 801 which can manipulate an interaction with a virtual object. In one embodiment, the user tilts the hand from starting position 800 to a tilt position 801. The virtual object is manipulated and is interacting with the user making a gesture. In this embodiment the virtual object interacts with the user making the tilt gesture 801 which represents a slide (a playground slide), and executes a predefined action, such as sliding the slide. In another embodiment, the virtual object interacts with a user making a gesture such as a circle shape conducted by the fingers and, for example, causing the virtual object to fly through the circle shape as if it was a tunnel. In another embodiment of the invention, a face gesture conducted by the user may manipulate a display of a computing device. In one embodiment, the virtual object interacts with a user making a face gesture such as a “kissing” and, for example, “sending” a kiss toward the virtual object.

In one embodiment of the invention, the gestures as described in FIGS. 6, 7, 7A, 7B, 7C, 7D, 7E and FIG. 8 may be used by the user for screen navigation and for display manipulation of one or more computing devices. This method of communication between several computing devices may be accomplished using what is known as a multiplayer gaming engine. The method establishes a communication link between the computing devices and a gaming server, the gaming server comprises a database which is configured to store real-time game information data for active game instances hosted on the gaming server. The method enables a gaming communication between two or more players, each of the players is playing in his computing device and in some cases can see the other user (or users) play in real-time.

In one embodiment of the invention, a user can make any of the gestures as described aforementioned which can operate screen navigation or display manipulation in one or more computing devices that are connected to the user. The connection between the user (“User A”) and the other user (“User B”) or with more users is established under the participation in the same game and through in-game communication (for example, invitation from User A to compete with User B in a specific game or scene in a game). In one embodiment of the invention User A can make any of the gestures as described aforementioned and change a TV program in User B computing device. In one embodiment of the invention User A can make any of the gestures as described aforementioned and “throw” a ball from his computing device to User B computing device. In one embodiment of the invention User A can make any of the gestures as described aforementioned and open or close an application in User B computing device. In one embodiment of the invention User A can make any of the gestures as described aforementioned and see the display of User B computing device.

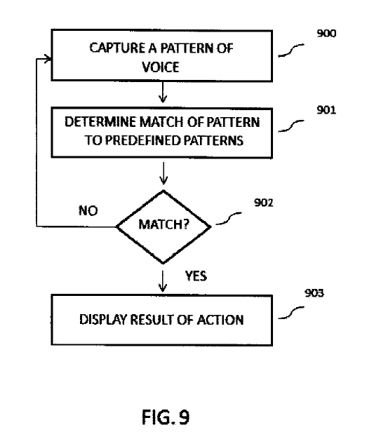

FIG. 9 is a flow chart diagram of a voice pattern control method for screen navigation and for display manipulation of a computing device, in accordance with some exemplary embodiments of the subject matter. In one embodiment a voice command by the user may execute an action of screen navigation. In one embodiment, more than one command at a time may be conducted (for example, two voice commands may be conducted at the same time and execute two functions at the same time). In one embodiment of the invention a voice command by the user may manipulate a display of a computing device (for example, a user can make a voice command which can manipulate an interaction with a virtual object, etc.). In one embodiment of the invention a voice command by the User A may manipulate a display of User B computing device.

In step 900, the voice capturing module 108, as described in FIG. 1, captures a sequence of voice pattern commands, and converts the patterns captured into a digital format.

In step 901, the interaction logic component 105, as described in FIG. 1, analyzes the voice patterns to determine whether the voice patterns captured in step 900 match one of the predefined gestures.

In step 902, the interaction logic component 105 classifies the patterns and to determine if the voice patterns captured in step 900 match one of the predefined gestures. If a match is found, the flow proceeds to step 903, displaying a result of the action on the screen. Otherwise, the flow goes back to step 900. In one embodiment of the invention, a voice command made by the first user can operate an action on the display of the second device.

1. A method of screen navigating; the method comprises the steps of:
a. classifying a gesture of a body organ as an action of screen navigation;
b. capturing an image of a body organ;
c. analyzing said image to determine whether the image matches said gesture of said body organ; and
d. executing said action of screen navigation if said image matches said body organ gesture.

2. The method of claim 1, wherein said body organ being a hand.

3. The method of claim 1, wherein said body organ being a face.

4. A method of activating a command on a computerized device; the method comprises the steps of:
a. by a first computerized device classifying a gesture of a body organ as an action of screen activation;
b. by said first computerized device capturing an image of said body organ;
c. by said first computerized device analyzing said image to determine whether the image matches said gesture; and
d. by said first computerized device sending a message to a second computerized device if said image matches said gesture; wherein said message being for activating a command on said second computerized device according to said hand gesture.

5. The method of claim 4, wherein said command comprising executing screen navigation.

6. The method of claim 4, wherein said command comprising manipulating a display of said second computerized device.

7. The method of claim 4, wherein said body organ being a hand.

8. The method of claim 4, wherein said body organ being a face.

9. A method of activating a command on a computerized device; the method comprises the steps of:
a. by a first computerized device classifying a voice pattern as an action of screen activation;
b. by said first computerized device capturing voice sample of a user;
c. by said first computerized device analyzing said voice sample determine whether the image matches said voice pattern; and
d. by said first computerized device sending a message to a second computerized device if said voice sample matches said voice pattern; wherein said message being for activating a command on said second computerized device according to said voice pattern.

10. The method of claim 9, wherein said command comprising executing screen navigation.

11. The method of claim 9, wherein said command comprising manipulating a display of said second computerized device.
